(19) United States
(12) Patent Application Publication
(10) Pub. No.: US 2010/0123350 A1
(43) Pub. Date: May 20, 2010

(54) Wheel and Balancer

(76) Inventor: Christopher King McNeill, Bedford, TX (US)

Correspondence Address: WILSON DANIEL SWAYZE, JR., 3804 CLEARWATER CT., PLANO, TX, 75025, US

(21) Appl. No.: 12/273,378

(22) Filed: Nov. 18, 2008

(51) Int. Cl. B60B 21/12

(52) U.S. Cl. 301/5.22

(57) ABSTRACT

A wheel for a tire may include a rim element for placement of the tire, a central element to cooperate with the rim element and the rim element having a first drop center section and a second drop center section. The second drop center section and the central element may cooperate to form a junction section having an enclosed circular balancing tube for a spatially balancing weight. The first drop center section may include a second circular balancing tube for a second spatially balancing weight. The first circular balancing tube may be a depression in the junction section.

### FIELD OF THE INVENTION

The present invention relates to automotive road wheels and more particularly pertains to a wheel and method for achieving a rotationally balanced tire/wheel assembly.

### BACKGROUND

Proper rotational balance of an automobile's tires is essential in order to provide a smooth ride, optimize handling characteristics, minimize wear and tear to the vehicle and extend the service life of the tires. A tire is normally balanced after its mounting to a wheel by the attachment of weight to the wheel. The balancing procedure typically includes the steps of spinning the tire/wheel assembly up to speed, measuring forces generated by any imbalance, determining the amount of weight and the precise placement of such weight necessary to counteract the measured forces and crimping the required weight to the wheel's outer edges or adhesively securing the weights to the wheel. The assembly is then again spun up to speed to confirm that proper balance has been achieved. Occasionally, the entire balancing procedure must be repeated if a further readjustment is found to be necessary.

Repeating the above-described procedure for every tire of every vehicle manufactured in a modern high-speed automobile assembly line amounts to a significant effort. Any reduction in such an expense would of course be advantageous. Reducing the amount of weight necessary or obviating the need to actually add balancing weight to a significant portion of a manufacturing line's throughput would in fact constitute such an improvement.

Eliminating the balancing weights from a wheel provides the secondary benefit of enhancing the aesthetic appearance of the wheel as the lead weights normally crimped onto or adhered to the outboard side of the wheel are generally considered unsightly.

Although wheels can be produced to very exacting standards with respect to rotational balance, it is much more difficult if not impossible to manufacture a balanced tire. The complex internal structure of modern tires defies efforts to achieve an even weight distribution from the outset while the elastic nature of the tire makes it difficult to predict, let alone compensate for, the distortion and its commensurate effect on balance caused by the extremely high g-forces a tire is subjected to at highway speeds. Producing a finely balanced tire to be mounted to a finely balanced wheel in order to yield a balanced tire/wheel assembly is therefore not a viable approach towards minimizing the labor normally expended in balancing an automobile's tires. Tire manufacturers do however have the ability to statically test each tire for imbalance and mark the tire carcass to indicate the location of the highest or lowest concentration of weight.

An alternative approach is therefore called for that provides a rotationally balanced tire/wheel assembly which requires only a minimal amount of weight addition and in a significant number of incidents, obviates the need to add any extraneous balancing weights whatsoever.

U.S. Pat. No. 3,913,980 discloses a user installable system of improved automobile wheel and tire dynamic balancing apparatus selectively positioned in the central longitudinal groove-way cavity of the wheel rim for a pneumatic tire.

U.S. Pat. No. 5,271,663 discloses an automotive roadwheel of preselected rotational imbalance, the amount of imbalance being selected to coincide with the average amount of imbalance inherent in the tires to be mounted to the wheel and the orientation of the imbalance being readily discernable such as by coinciding with the location of the valve stem. The method calls for the heaviest orientation of the wheel to be aligned with the lightest orientation of the tire (or vice versa) during the mounting process to yield a balanced tire/wheel assembly without the need to add balancing weight in the majority of such assemblies.

U.S. Pat. No. 6,318,446 discloses a one piece cast wheel having a lightener recess formed in the wheel disc which extends axially beneath the wheel outboard tire bead seat. A method of casting such a one piece wheel which utilizes a multi-piece wheel mold having side members includes a plurality of components. A core for forming the lightener cavity is formed integrally with the side member components. The side member components are sequentially moved relative to each other to release the core from the lightener cavity.

### SUMMARY

A wheel for a tire may include a rim element for placement of the tire, a central element to cooperate with the rim element and the rim element having a first drop center section and a second drop center section.

The second drop center section and the central element may cooperate to form a junction section having an enclosed circular balancing tube for a spatially balancing weight.

The second drop center section may include a circular balance tube for a spatially balancing weight.

The first drop center section may include a second circular balancing tube for a second spatially balancing weight.

The first circular balancing tube may be a depression in the junction section.

The rim element may include an inner flange element, and the rim element may include an outer flange element.

The center element may include a hub section, and the center element may include a lug hole.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a first wheel of the present invention;

FIG. 2 illustrates a second wheel of the present invention;

FIG. 3 illustrates a third wheel of the present invention;

FIG. 4 illustrates a fourth wheel of the present invention.

### DETAILED DESCRIPTION

The components of the balancer of the present invention which may include rings, weights fluid and adhesives may be inert after manufacture. This allows little or no environmental impact to the accident site if an accident should occur which could compromise and/or damage the balancing system of the present invention.

The balancing system may be employed in consumer, performance, commercial and industrial wheel types which may include automobile, light-truck and semi truck wheels or other types of wheels.

The grooves may be manufactured into the wheel itself.

These grooves/cavities can be placed in any suitable location about or in the wheel to ensure proper balance, giving consideration to the width, diameter, offset, drop center, anticipated tire size and other imbalance correction design parameters.

The positioning of the balance system groups may also be placed to take into consideration the necessary clearances between the wheel and brake caliper.

The balance system may be used on cast or billet wheel designs or other types of wheel designs.

The balancer rings or ring may be an integral part of the wheel and may be hidden to the user or viewer when being observed from the outside or streetside of the wheel.

The balancer tubes may be protected by the cavity from damage from road debris and maintenance handling.

For use on wider large wheels, depending on the offset, it may be possible to use multiple balancers and may have two or more grooves. The multiple balancers and grooves may be positioned at different positions in order to near maximize the effect of the balancing system.

The balance system may correct imbalances not only of the wheel/tire assembly but all the components that may rotate on the bearings and may include the hub, break disc/drum and wheel/tire assemblies combined.

The balance system may allow the tire to run at lower temperatures which may result from the decreased vibration due to the improved tolerance of the over all balancing and improved tolerance of overall balance which may promote a longer tire life and increase safety.

The balance system of the present invention may continuously adjust the balance as a result of changes in balance due to tire wear, brake rotor or brake drum wear and the accumulation of road grime or mud or other factors in accordance with the design limits of the balancing system.

The balance system may reduce the handling damage to the wheel assembly from maintenance employees because the present invention eliminates the need to place the wheel/tire assembly on a shaft type balancer and should eliminate the need to use lead or other weights which have to be manually applied to the rim.

The balance system may reduce the external balance weights from being prematurely removed from the wheel and consequently may ensure that the wheel would or will remain in balance under most conditions and may prevent damage to other vehicles or to the vehicle itself when these weights are prematurely removed.

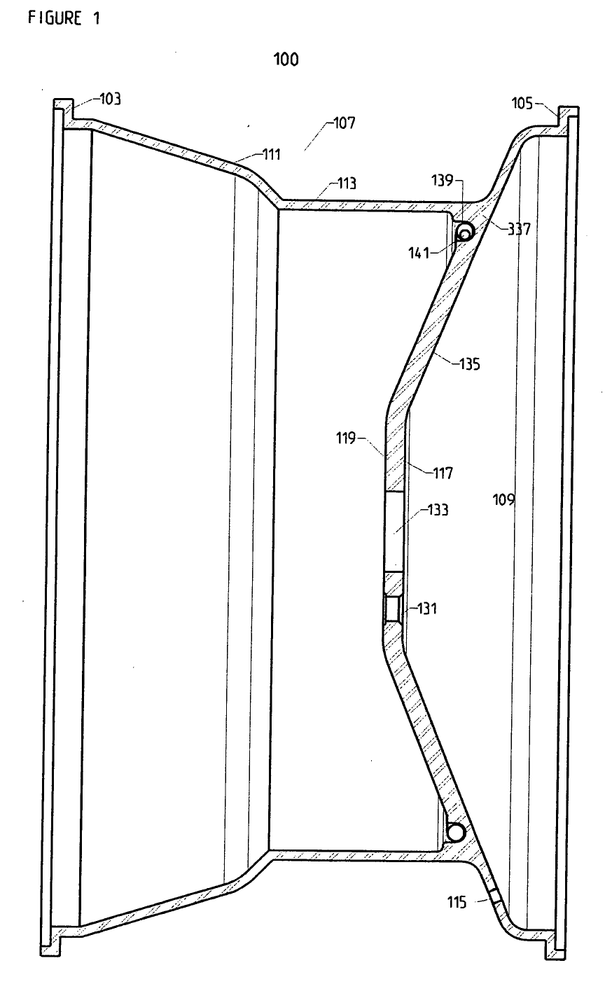

FIGS. 1-4 generally illustrate automotive road wheels according to the present invention. The various embodiments depicted illustrate the configuration and location of cavities disposed in a wheel that serve to impart a preselected degree of imbalance to the wheel in order to correct for imbalances which are inherent in the wheel and tire.

FIG. 1 is a side view of a wheel 100. The wheel generally may include a rim element 107 and a center element 109. The rim element 107 generally defines a cylinder or other appropriate shape while its ends are formed to provide an inner and outer flange elements 103, 105. The middle of the cylindrical rim element has a “drop center” section of reduced diameter. The drop center section may include a first drop center section 111 of a first reduced diameter and may include a second drop center section 113 of a second reduced diameter. The entire rim element 105 may be impermeable to air while valve stem hole 115 sets the interior of the cylinder in communication with its exterior.

The center element 109 of wheel 100 may include a centrally disposed hub section 117 that may facilitate the mounting of wheel 100 to a vehicle's hub. The hub section 117 has a substantially flat inboard mating surface 119 and may be perforated by a central hub hole 133 and a plurality of lug holes 131. In the embodiment illustrated, a plurality of spokes 135 interconnect the hub section 117 with the rim element 107. Aesthetic considerations typically dictate the particular configuration of this part of the wheel and various spoke designs as well as flat solid disks, disks with various patterns of perforations therein and basket-weave type designs are common.

FIG. 1 illustrates a juncture section 135 which may be positioned between the interior surface of the rim element 107 and the center element 109. More particularly, the juncture section 135 may be positioned between the interior surface of the second drop center section 113 and the center element 109 in which a single or a plurality of first circular balancing tubes 139 which may be longitudinally disposed around the circumference of the rim element 107 in order to provide a track for spatially balancing weights 141. The circular balancing tube 139 may be continuous around the circumference of the rim element 107. The cross-section of the circular balancing tube 139 maybe circular, oval, U-shaped or other appropriate shape. The circular balancing tube 139 and the spatially balancing weights 141 may cooperate to impart a preselected degree of imbalance to the wheel 100. The circular balancing tube 139 may be completely enclosed by the juncture section 137 or may include a slit to the interior of the wheel 100.

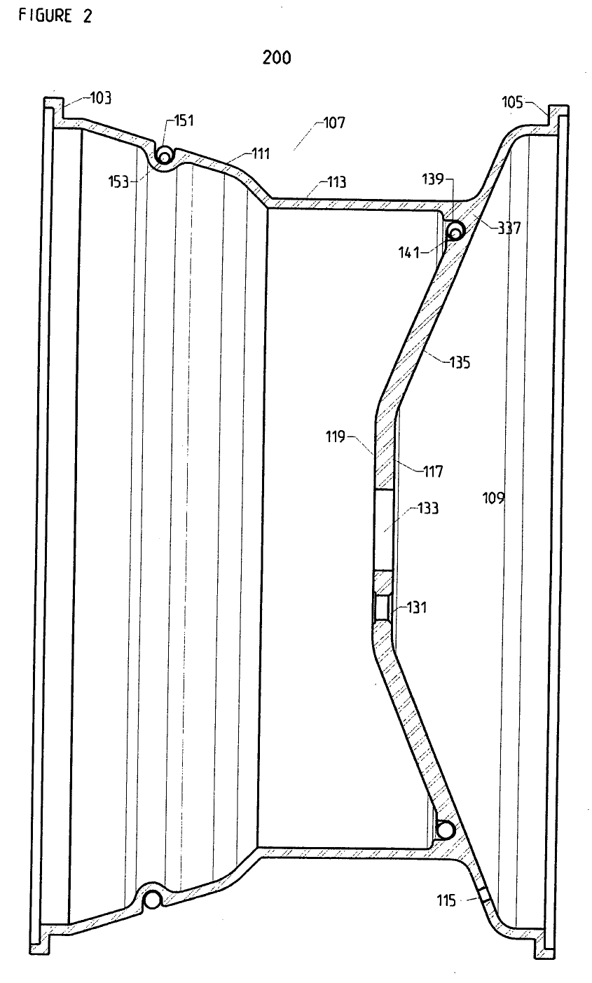

FIG. 2 is a side view of a wheel 200. The wheel generally may include a rim element 107 and a center element 109. The rim element 107 generally defines a cylinder or other appropriate shape while its ends are formed to provide an inner and outer flange elements 103, 105. The middle of the cylindrical rim element has a “drop center” section of reduced diameter. The drop center section may include a first drop center section 111 of a first reduced diameter and may include a second drop center section 113 of a second reduced diameter. The entire rim element 105 may be impermeable to air while valve stem hole 115, sets the interior of the cylinder in communication with its exterior.

The center element 109 of wheel 200 may include a centrally disposed hub section 117 that may facilitate the mounting of wheel 100 to a vehicle's hub. The hub section 117 has a substantially flat inboard mating surface 119 and may be perforated by a central hub hole 133 and a plurality of lug holes 131. In the illustration, a plurality of spokes 135 interconnect the hub section 117 with the rim element 107. Aesthetic considerations typically dictate the particular configuration of this part of the wheel and various spoke designs as well as flat solid disks, disks with various patterns of perforations therein and basket-weave type designs are common.

FIG. 2 illustrates a juncture section 137 which may be positioned between the interior surface of the rim element 107 and the center element 109. More particularly, the juncture section 137 may be positioned between the interior surface of the second drop center section 113 and the center element 109 in which a single or a plurality of first circular balancing tubes 139 which may be longitudinally disposed around the circumference of the rim element 107 in order to provide a track for spatially balancing weights 141. The circular balancing tube 139 may be continuous around the circumference of the rim element 107. The cross-section of the circular balancing tube 139 maybe circular, oval, U-shaped or other appropriate shape. The circular balancing tube 139 and the spatially balancing weights 141 may cooperate to impart a preselected degree of imbalance to the wheel 100. The circular balancing tube 139 may be completely enclosed by the juncture section 137 or may include a slit to the interior of the wheel 200.

FIG. 2 additionally illustrates a circular balancing tube 151 or depression or a plurality of circular balancing tubes 151 which may be formed on the first drop center section 111 to provide a track for the spatially balancing weight 153. The circular balancing tube 151 and the spatially balancing weights 153 may cooperate to impart a preselected degree of imbalance to the wheel 200. The cross-section of the circular balancing tube 151 maybe circular, oval, U-shaped or other appropriate shape.

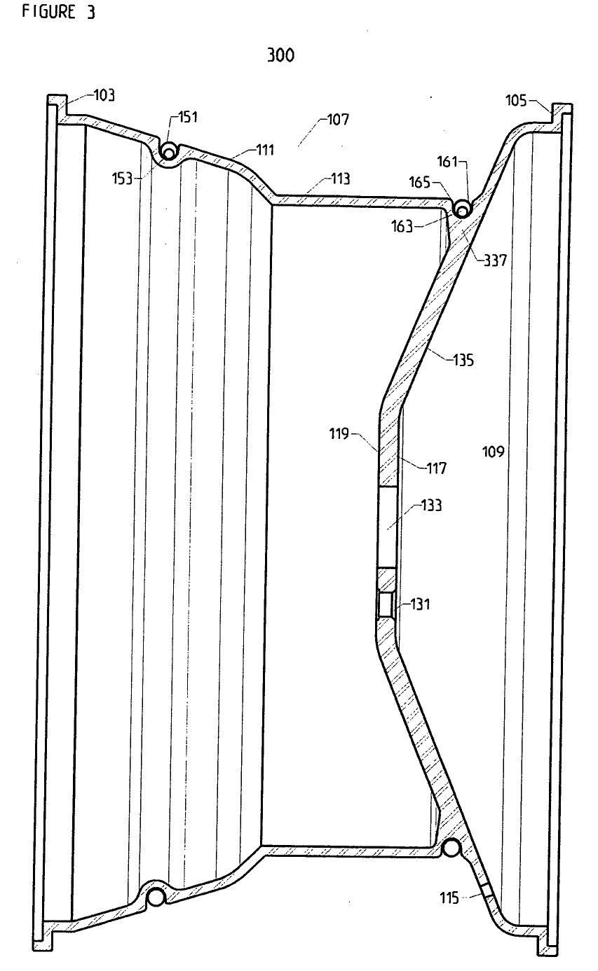

FIG. 3 is a side view of a wheel 300. The wheel 300 generally may include a rim element 107 and a center element 109. The rim element 107 generally defines a cylinder or other appropriate shape while its ends are formed to provide an inner and outer flange elements 103, 105. The middle of the cylindrical rim element has a “drop center” section of reduced diameter. The drop center section may include a first drop center section 111 of a first reduced diameter and may include a second drop center section 113 of a second reduced diameter. The entire rim element 105 may be impermeable to air while valve stem hole 115, sets the interior of the cylinder in communication with its exterior.

The center element 109 of wheel 300 may include a centrally disposed hub section 117 that may facilitate the mounting of wheel 300 to a vehicle's hub. The hub section 117 has a substantially flat inboard mating surface 119 and may be perforated by a central hub hole 133 and a plurality of lug holes 131. In the illustration, a plurality of spokes 135 interconnects the hub section 117 with the rim element 107. Aesthetic considerations typically dictate the particular configuration of this part of the wheel and various spoke designs as well as flat solid disks, disks with various patterns of perforations therein and basket-weave type designs are common.

FIG. 3 illustrates a juncture section 337 which may be positioned between the rim element 107 and the center element 109. More particularly, the juncture section 337 may be positioned between the interior surface of the second drop center section 113 and the center element 109 in which a single or a plurality of second circular balancing tubes 161 or depression which may be longitudinally disposed around the circumference of the rim element 107 and more particularly in the second drop center section 113 in order to provide a track for spatially balancing weights 163. The circular balancing tube 161 may be continuous around the circumference of the rim element 107. The cross-section of the circular balancing tube 161 maybe circular, oval, U-shaped or other appropriate shape. The circular balancing tube 161 and the spatially balancing weights 163 may cooperate to impart a preselected degree of imbalance to the wheel 100. The circular balancing tube 161 may be completely enclosed by the juncture section 337 or may include a slit 165 to the interior of the wheel 300.

FIG. 3 additionally illustrates a circular balancing tube 151 or depression or a plurality of circular balancing tubes 151 which may be formed on the first drop center section 111 to provide a track for the spatially balancing weight 153. The circular balancing tube 151 and the spatially balancing weights 153 may cooperate to impart a preselected degree of imbalance to the wheel 300. The cross-section of the circular balancing tube 151 maybe circular, oval, U-shaped or other appropriate shape.

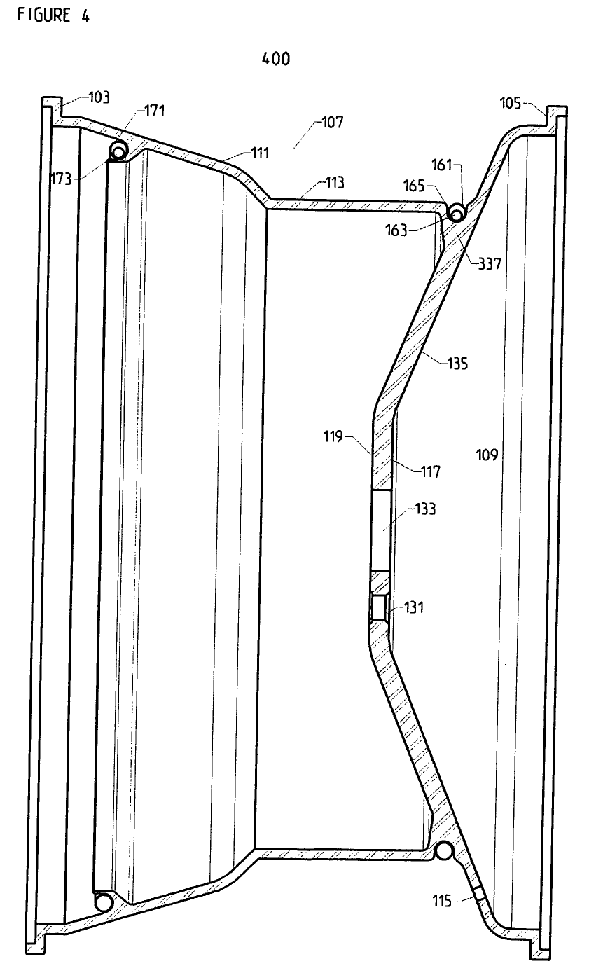

FIG. 4 is a side view of a wheel 400. The wheel 400 generally may include a rim element 107 and a center element 109. The rim element 107 generally defines a cylinder or other appropriate shape while its ends are formed to provide an inner and outer flange elements 103, 105. The middle of the cylindrical rim element has a “drop center” section of reduced diameter. The drop center section may include a first drop center section 111 of a first reduced diameter and may include a second drop center section 113 of a second reduced diameter. The entire rim element 105 may be impermeable to air while valve stem hole 115, sets the interior of the cylinder in communication with its exterior.

The center element 109 of wheel 400 may include a centrally disposed hub section 117 that may facilitate the mounting of wheel 400 to a vehicle's hub. The hub section 117 has a substantially flat inboard mating surface 119 and may be perforated by a central hub hole 133 and a plurality of lug holes 131. In the illustration, a plurality of spokes 135 interconnects the hub section 117 with the rim element 107. Aesthetic considerations typically dictate the particular configuration of this part of the wheel and various spoke designs as well as flat solid disks, disks with various patterns of perforations therein and basket-weave type designs are common.

FIG. 4 illustrates a juncture section 337 which may be positioned between the rim element 107 and the center element 109. More particularly, the juncture section 337 may be positioned between the interior surface of the second drop center section 113 and the center element 109 in which a single or a plurality of second circular balancing tubes 161 or depression which may be longitudinally disposed around the circumference of the rim element 107 and more particularly in the second drop center section 113 in order to provide a track for spatially balancing weights 163. The circular balancing tube 161 may be continuous around the circumference of the rim element 107. The cross-section of the circular balancing tube 161 maybe circular, oval, U-shaped or other appropriate shape. The circular balancing tube 161 and the spatially balancing weights 163 may cooperate to impart a preselected degree of imbalance to the wheel 100. The circular balancing tube 161 may be completely enclosed by the juncture section 337 or may include a slit 165 to the interior of the wheel 300.

FIG. 4 additionally illustrates a circular balancing tube 171 or depression or a plurality of circular balancing tubes 171 which may be formed on the interior of the first drop center section 111 to provide a track for the spatially balancing weight 173. The circular balancing tube 171 and the spatially balancing weights 173 may cooperate to impart a preselected degree of imbalance to the wheel 400. The cross-section of the circular balancing tube 171 maybe circular, oval, U-shaped or other appropriate shape.

The above described tubes and depressions of the present invention can be formed by a variety of methods. In the case of a cast wheel, for example, appropriate protrusions can be formed in the molds into which the aluminum alloy is cast in order to form the cavities in the resulting wheel. Alternatively, the above depressions can be machined into a wheel after completion of its initial manufacturing process.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A wheel for a tire, comprising:
a rim element for placement of the tire;
a central element to cooperate with the rim element;
the rim element having a first drop center section and a second drop center section;
wherein the second drop center section and the central element cooperate to form a junction section having an enclosed circular balancing tube for a spatially balancing weight.

2. A wheel for a tire as in claim 1, wherein the rim element includes an inner flange element.

3. A wheel for a tire as in claim 1, wherein the rim element includes an outer flange element.

4. A wheel for a tire as in claim 1, wherein the center element includes a hub section.

5. A wheel for a tire as in claim 1, wherein the center element includes a lug hole.

6. A wheel for a tire, comprising:
a rim element for placement of the tire;
a central element to cooperate with the rim element;
the rim element having a first drop center section and a second drop center section;
wherein the second drop center section and the central element cooperate to form a junction section having a first enclosed circular balancing tube for a spatially balancing weight;
wherein the first drop center section includes a second circular balancing tube for a second spatially balancing weight.

7. A wheel for a tire as in claim 6, wherein the rim element includes an inner flange element.

8. A wheel for a tire as in claim 6, wherein the rim element includes an outer flange element.

9. A wheel for a tire as in claim 6, wherein the center element includes a hub section.

10. A wheel for a tire as in claim 6, wherein the center element includes a lug hole.

11. A wheel for a tire, comprising:
a rim element for placement of the tire;
a central element to cooperate with the rim element;
the rim element having a first drop center section and a second drop center section;
wherein the second drop center section and the central element cooperate to form a junction section having a first circular balancing tube for a spatially balancing weight, wherein the first circular balancing tube is a depression in the junction section;
wherein the first drop center section includes a second circular balancing tube for a second spatially balancing weight.

12. A wheel for a tire as in claim 11, wherein the second circular balancing tube is enclosed by the first center drop section.

13. A wheel for a tire as in claim 11, wherein the rim element includes an inner flange element.

14. A wheel for a tire as in claim 11, wherein the rim element includes an outer flange element.

15. A wheel for a tire as in claim 11, wherein the center element includes a hub section.

16. A wheel for a tire as in claim 11, wherein the center element includes a plurality of lug holes.
